(19) United States
(12) Patent Application Publication
(10) Pub. No.: US 2013/0067497 A1
(43) Pub. Date: Mar. 14, 2013

(54) APPARATUS AND METHOD FOR SETTING A USER-DEFINED PATTERN FOR AN APPLICATION

(71) Applicants: Kwang-Seok SEO, Seoul (KR); Yu-Ri AHN, Seoul (KR)

(72) Inventors: Kwang-Seok SEO, Seoul (KR); Yu-Ri AHN, Seoul (KR)

(73) Assignee: Pantech Co., Ltd., Seoul (KR)

(21) Appl. No.: 13/523,249

(22) Filed: Jun. 14, 2012

(30) Foreign Application Priority Data
Sep. 9, 2011 (KR) 10-2011-0092193

(51) Int. Cl. G06F 9/46

(52) U.S. Cl. 719/318

(57) ABSTRACT

In an apparatus to set a user-defined pattern for use in executing an application, the apparatus sets pattern information that indicates at least one of an input value according to a user input signal and an input value according to an input method for sensing information, and extracts task information of an application. Then, the apparatus generates mapping information based on the pattern information and the task information such that an application task corresponding to pattern information that is input in response to a user input signal is executed. A method for setting a reference pattern, including: receiving a first input; setting the reference pattern based on the first input; and mapping the reference pattern to an event of an application, wherein the event is executed in response to a duplication of the reference pattern.

### CROSS-REFERENCE TO RELATED APPLICATION

This application claims priority from and the benefit under 35 U.S.C. §119(a) of Korean Patent Application No. 10-2011-0092193, filed on Sep. 9, 2011, which is hereby incorporated by reference for all purposes as if fully set forth herein.

### BACKGROUND

1. Field

Exemplary embodiments of the present invention relate to an apparatus and method for setting a user-defined pattern for an application.

2. Discussion of the Background

In mobile terminal devices, some operations associated with the device are executed based on a manufacturer or application developer's predetermined settings. Thus, a user learns input techniques and combinations that may not be intuitive. Additionally, the input techniques are confined to the combinations provided by an application.

Korean Patent Publication No. 10-2008-0069421 discloses a method and apparatus for processing a short touch pattern published on Jul. 28, 2008. However, as the operations are predefined, it may be difficult for a user to intuitively access an operation of a terminal device in an easy to remember and convenient manner.

The above information disclosed in this Background section is only for enhancement of understanding of the background of the invention and therefore it may contain information that does not form any part of the prior art.

### SUMMARY OF THE INVENTION

Exemplary embodiments of the present invention provide an apparatus and method for setting a user-defined pattern, which may be used as a reference pattern for the subsequent execution of a task associated with an application embedded or integrated with a device.

Additional features of the invention will be set forth in the description which follows, and in part will be apparent from the description, or may be learned by practice of the invention.

An exemplary embodiment of the present invention discloses device to execute an application, including: an input unit to receive a first input and a second input; a pattern setting unit to set a reference pattern based on the first input and to map the reference pattern to an event of the application; and a control unit to execute the event in response to the second input corresponding to the reference pattern.

An exemplary embodiment of the present invention discloses a method for executing an application, including: receiving a first input and a second input; setting a reference pattern based on the first input; mapping the reference pattern to an event; and executing the event in response to the second input corresponding to the reference pattern

An exemplary embodiment of the present invention discloses a method for setting a reference pattern, including: receiving a first input; setting the reference pattern based on the first input; and mapping the reference pattern to an event of an application, wherein the event is executed in response to a duplication of the reference pattern.

It is to be understood that both the forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an application executing apparatus according to an exemplary embodiment of the present invention.

FIG. 2 is a block diagram illustrating a pattern managing unit according to an exemplary embodiment.

FIG. 3 is a table showing pattern information according to an exemplary embodiment of the present invention.

FIG. 4 is a table showing task information according to an exemplary embodiment of the present invention.

FIG. 5 is a block diagram illustrating an application service providing unit according to an exemplary embodiment of the present invention.

FIG. 6A is a table showing mapping information according to an exemplary embodiment of the present invention, and FIG. 6B is a table showing mapping information according to an exemplary embodiment.

FIG. 7 is a flowchart of a method for setting user-defined pattern according to an exemplary embodiment of the present invention.

FIG. 8 is a flowchart illustrating a method for executing an application using a user-defined pattern according to an exemplary embodiment of the present invention.

FIG. 9A is an illustration showing the setting of a user-defined pattern according to an exemplary embodiment of the present invention. FIG. 9B is an illustration showing the setting of a user-defined pattern according to an exemplary embodiment of the present invention. FIG. 9C is an illustration showing the setting of a user-defined pattern according to an exemplary embodiment of the present invention. FIG. 9D is an illustration showing the setting of a user-defined pattern according to an exemplary embodiment of the present invention. FIG. 9E is an illustration showing the setting of a user-defined pattern according to an exemplary embodiment of the present invention. FIG. 9F is an illustration showing the setting of a user-defined pattern according to an exemplary embodiment of the present invention. FIG. 9G is an illustration showing the setting of a user-defined pattern according to an exemplary embodiment of the present invention.

FIG. 10A is an illustration showing task extracting based on a user-defined pattern according to an exemplary embodiment of the present invention. FIG. 10B is an illustration showing task extracting based on a user-defined pattern according to an exemplary embodiment of the present invention. FIG. 10C is an illustration showing task extracting based on a user-defined pattern according to an exemplary embodiment of the present invention. FIG. 10D is an illustration showing task extracting based on a user-defined pattern according to an exemplary embodiment of the present invention. FIG. 10E is an illustration showing task extracting based on a user-defined pattern according to an exemplary embodiment of the present invention. FIG. 10F is an illustration showing task extracting based on a user-defined pattern according to an exemplary embodiment of the present invention. FIG. 10G is an illustration showing task extracting based on a user-defined pattern according to an exemplary embodiment of the present invention. FIG. 10H is an illustration showing task extracting based on a user-defined pattern according to an exemplary embodiment of the present invention. FIG. 10I is an illustration showing task extracting based on a user-defined pattern according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

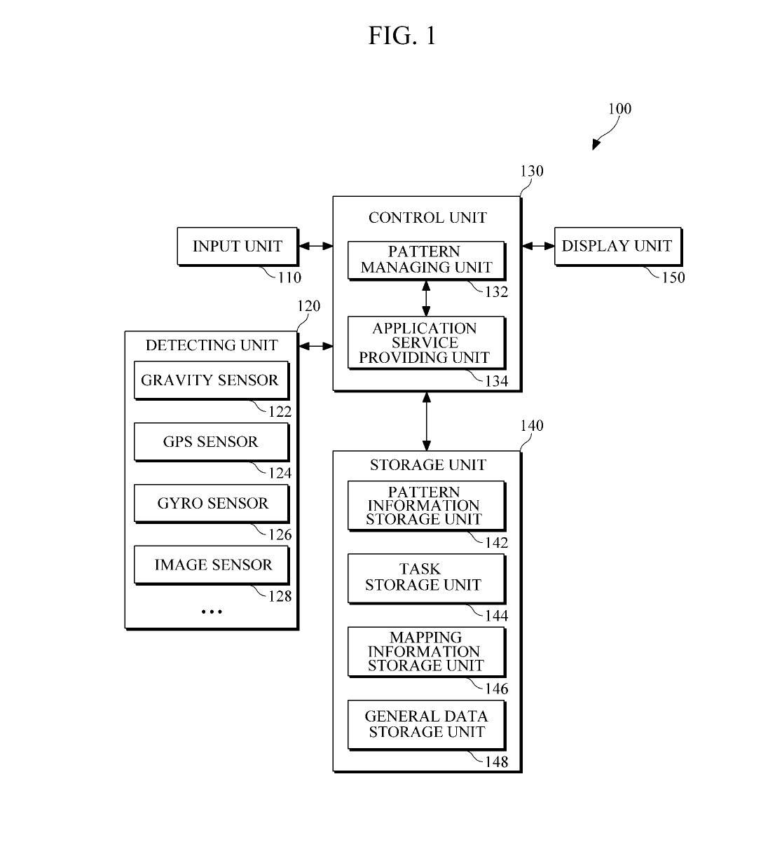

FIG. 1 is a diagram illustrating an application executing apparatus according to an exemplary embodiment of the present invention.

An application executing apparatus 100 executes a task of an application in response to a user entering in an input, which may be a pattern. The application executing apparatus 100 may be included in or implemented as any terminal apparatus, such as a smartphone, a mobile phone, a personal digital assistant, and the like.

In this disclosure, the term “event” is used to indicate any sort of executable element of an application. Thus, event may refer to a process of an application, a task of an application, or the application itself. Further, the various terms described above may be substituted with each other according to various aspects described within the disclosure.

Referring to FIG. 1, the application executing apparatus 100 includes an input unit 110, a detecting unit 120, a control unit 130, a storage unit 140, and a display unit 150.

The input unit 110 may refer to one or more of various user input devices, such as a keypad, user input buttons, a touch display, a motion sensor, and the like. The input unit 110 may receive an input signal and transmit the received input signal to the control unit 130.

The detecting unit 120 may include a sensor to detect one or more of various environmental conditions, such as motion, temperature, pressure, and the like, of the application executing apparatus 100. The motion of the application executing apparatus 100 may include the change of location of an application executing apparatus 100, a posture change of a user, or the like. A change in location, or motion, of the application executing apparatus 100 may be caused by the user, and thus the detecting unit 120 may also serve as an input device or input unit 110.

The detecting unit 120 may include a gravity sensor 122, a global positioning system (GPS) sensor 124, a gyro sensor 126, a geomagnetic sensor (not shown), and the like, in order to detect various changes in the device. In addition, the detecting unit 120 may further include an image sensor 128 and an audio sensor (not shown), in order to detect a luminance, background sound, and voice input. The detecting unit 120 may generate sensing data. According to sensors included in the detecting unit 120, the application executing apparatus 100 may generate at least one type of corresponding information, such as motion information, posture information, image information, and audio information, as sensing information.

The control unit 130 may control the operation of the application executing apparatus 100 by transmitting and receiving data and a control signal to and from the input unit 110, the detecting unit 120, the storage unit 140, and the display unit 150. The control unit 130 executes an operating system and an application of the application executing apparatus 100. The control unit 130 may be a data processing device, such as a processor or a digital signal processor that executes an application and processes data. The control unit 130 may execute an application, or execute general execution operations associated with a specific event of the application. In addition, the control unit 130 may control the execution of a specific task of the application according to a pattern defined by the user.

The control unit 130 may include a pattern managing unit 132 and an application service providing unit 134. The pattern managing unit 132 may manage pattern information based on a user-defined pattern. The pattern information may correspond to an input via the input unit 110 or an input via the detecting unit 120. The pattern managing unit 132 may create a template, such as an image, for a user to set pattern information and provide the image via the display unit 150. Once the pattern information is set, the pattern managing unit 132 may store the set pattern information in the storage unit 140.

The pattern managing unit 132 may generate mapping information including pattern information, and an application (or task of an application) that corresponds to the pattern information. The pattern managing unit 132 may generate the mapping information by mapping the pattern information with the application, and manage the generated mapping information. The pattern managing unit 132 may provide an interactive display on the display unit 150 in order to receive pattern information, receive the user input signal to be associated with an application, and generate (or create) mapping information based on the pattern information and the application. The pattern information may correspond to a user input signal.

The pattern managing unit 132 may extract and manage tasks associated with an application. The tasks, which may correspond to information to execute a specific part of an application, may refer to various forms of information according to types of applications and operating systems (OS) on which the applications are executed on. In an example, the task may be defined by an application developer and embedded into the application. The task may include a runtime record that may be extracted in the course of executing an application in response to a user input signal, and a macro record that may be a group of runtime records. The macro record may include touch coordinates detected in response to an input signal, identification information of an application running if a touch is detected, an application state, an event (or an instruction) delivered to an application in response to the detection of touch, and a result of the execution of the delivered application event.

If information of the execution of a task, for example, time information, is included in the runtime record or the macro record and not selected to be viewed by a user, the runtime record or the macro record may be processed into a format that may be mapped to pattern information. The runtime record may correspond to information associated with the execution of a task, and the macro record may correspond to a group of runtime records which are collected in response to an input signal to extract the information associated with a group of tasks that are executed.

Hereinafter, information in an application is referred to as application information, and information extracted from a macro record or a macro record that has not been defined by an application but reports the execution of a process is referred to as execution information.

The pattern managing unit 132 may be similar to a user-defined pattern setting apparatus.

The application service providing unit 134 may execute an application, in a manner in which the application is normally executed. In addition, the application service providing unit 134 executes an application in response to a user-defined pattern. The application service providing unit 134 may receive at least one of a user input signal and an action that triggers a sensor, generate input pattern information, search for pattern information corresponding to the input pattern information and a task mapped to the pattern information from the mapping information, and execute an application or task corresponding to the retrieved mapped task. The application service providing unit 134 may provide the user information about the execution of the application through the display unit 150.

The storage unit 140 may store data and content used for the operation of the application executing apparatus 100. The storage unit 140 may include a pattern information storage unit 142, a task storage unit 144, a mapping information storage unit 146, and a general data storage unit 148.

The pattern information storage unit 142 may store pattern information that corresponds to user-defined patterns managed by the pattern managing unit 132. The task storage unit 144 may store task information of an application. The task information may be differentiated between various tasks from other applications. The mapping information storage unit 146 may store the mapping information. The general data storage unit 148 may store an OS and an executable application.

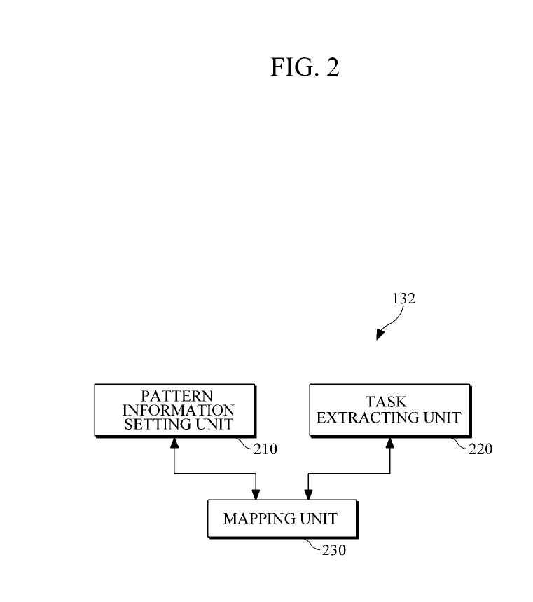

FIG. 2 is a block diagram illustrating a pattern managing unit according to an exemplary embodiment.

The pattern managing unit 132 may include a pattern information setting unit 210, a task extracting unit 220, and a mapping unit 230. Each of the pattern information setting unit 210, the task extracting unit 220, and the mapping unit 230 may be connected to the input unit 110 as a display to provide an interactive environment with a user.

The pattern information setting unit 210 enables a user to set pattern information to indicate at least one of a user input signal and an action that triggers a sensor. The pattern information setting unit 210 may provide a pattern information setting window to the display unit 150 so that a user may set an input value and an action that triggers a sensor. In one example, the inputting of pattern information may be associated with at least one of a: a user input signal, an action that triggers a sensor, and the like. For example, the pattern information may consist of the combination of an input value of a gravity sensor (G sensor) and a plurality of coordinate values obtained from multi-touches. The pattern information setting unit 210 may store the pattern information set in response to an input signal in the pattern information storage unit 142.

The task extracting unit 220 may extract task information of an application and store the extracted task information in the task information storage unit 144.

The task extracting unit 220 may extract application information that has been previously defined in the application upon installation. The task extracting unit 220 may provide a display to a list of application information predefined, or available, by an application to allow the user to select at least one of the tasks associated with the application.

The task extracting unit 220 may collect a runtime record, as information for use in executing an application task, which is generated from executing an application in response to a user input signal. The task extracting unit 220 may extract a macro record as execution information, wherein the macro record indicates one or more collected runtime records. The task extracting unit 220 may collect the runtime record generated in executing an application in response to a user input, in connection with the application service providing unit 134 and an application executing unit 520.

The task extracting unit 220 may collect a runtime record during a period between the input time of the first user input signal and the input time of the second user input signal, wherein the first user input signal instructs start of a collection of runtime records and the second user input signal instructs an end of the collection of runtime records. The task extracting unit 220 may provide a window that includes an icon to start recording and an icon to end recording, with the start and end corresponding to recordation of runtime associated with execution information.

The task information may include task ID information, application ID information, application state information and information of an event to occur for the execution of a task.

The application ID information indicates unique identification information of an application, in order to differentiate the application from other applications. If an application performs multiple processes that produce processing results in response to a user input and a task is related to one of the processes, the application ID information may further include process identification information for identifying each process of the application.

The application state information indicates an activity shown on the display during the interaction between the application and the user, or if a service is running in the background. For example, the application state information may indicate whether the application is in a foreground or a background state.

The event information indicates an event that occurs to cause a task to execute, and may be further correlated to the application information and the application state information. Specifically, the event information is information of a task, application or event that is generated in response to a user input or change of a system state in an application, and may be detectable by the application. The application performs a task in response to detecting a specific event.

The mapping unit 230 may generate mapping information by mapping the pattern information and the task information, with the generation occurring in response to a user input signal. The mapping unit 230 may configure a window to display settings to be programmed in response to a user input signal, and provide the window to the display unit 150. The pattern information indicates at least one of an input signal and an action that triggers a sensor. The task information indicates a task to be executed in connection with an event, such as a specific occurrence during the execution of an application or a user input signal. The mapping unit 230 may generate the mapping information by allowing a user to select the pattern information and task information to be mapped with each other.

In generating the mapping information, the mapping unit 230 may verify to ensure that the same pattern information is not mapped to two or more pieces of task information. If the selected task information corresponds to execution information (or is generated from a macro record) the mapping unit 230 may generate mapping information by mapping of the selected task information to a recorded pattern information.

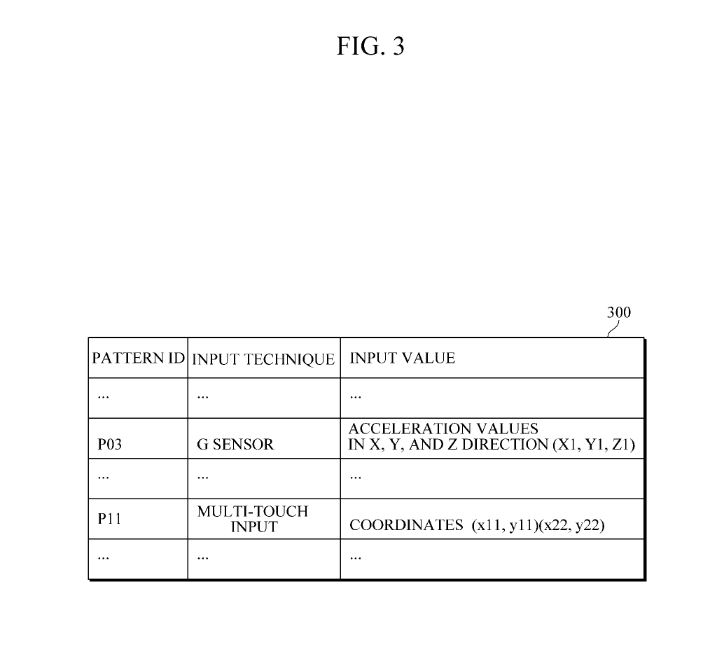

FIG. 3 is a table showing pattern information according to an exemplary embodiment of the present invention.

The pattern information may include a pattern ID and a corresponding input technique. The input technique may refer how the input is received, such as through a user input signal, through a sensor, or the combination of these techniques. Other user input techniques may include a key input, single touch input and multi-touch input, a G sensor, a GPS sensor, a gyro sensor, an image sensor, a geomagnetic sensor, and the like.

Referring to the table 300, one row entry is a pattern ID of P03, corresponding to an input technique of a ‘G sensor’, and an input value of acceleration values (x1, y1, z1) in X-, Y-, and Z-axis direction. Another row is a pattern ID of P11, corresponding to an input technique of a ‘MULTI-TOUCH INPUT’, and an input value of coordinates (x11, y11), (x22, y22) of multi-touch. These are examples of various entries used for configuring pattern information, and other concepts described in this disclosure, with various combinations of such, may also be implemented.

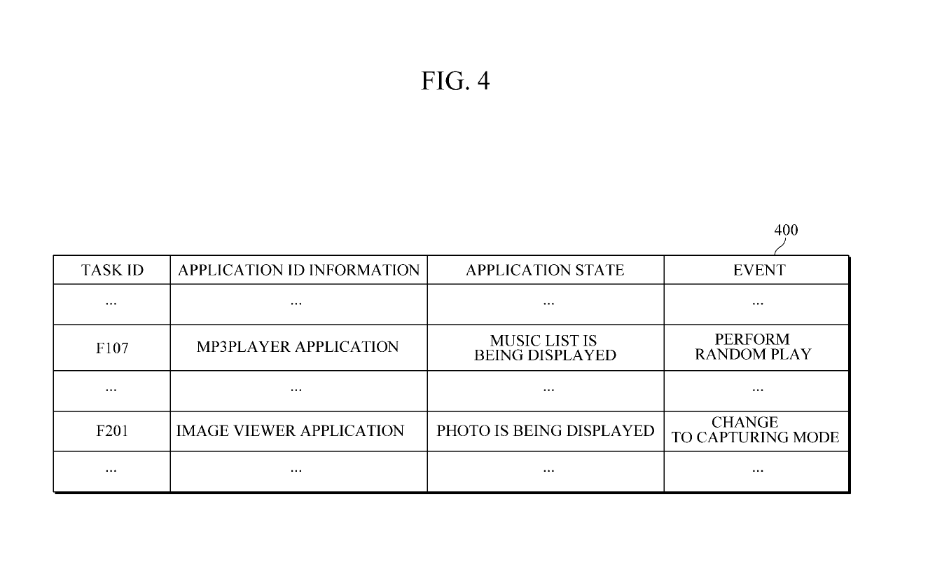

FIG. 4 is a table showing task information according to an exemplary embodiment of the present invention.

The task information may include task information ID (task ID), application identification (ID) information, application state information and event information. If an application performs a plurality of processes or tasks that produce processing results in response to a user input, the application ID information may further include identification information for identifying the application and process identification information specific to a process or task. The application state information may be selectively included along with the task information.

Referring to a table 400 shown in FIG. 4, various rows of task information are shown. For example, one row has F107 as a task ID, corresponding to an ‘MP3 player application’ as application ID information, ‘music list is being displayed’ as application state information, and ‘perform random play’ as event information. Here, the application ID information may be an application name or an identifier, such as a number or symbol that represents the application. Although ‘music list is being displayed’ is provided as an example of the application state information in FIG. 4, a unique identifier of each for application state information may be used. ‘Perform random play’ signifies an event that executes a task for changing a music play mode to a random play if the application is a ‘MP3 player application’ and in a state where the ‘music list is being displayed’. The event information may be a unique identifier of an event that enables execution of a random play task.

Another row has F201 as a task ID, corresponding to a ‘photo viewer application’ as application ID information, ‘photo is being displayed’ as application state information, and ‘change to capturing mode’ as event information. These are examples of various entries used for configuring task information, and other concepts described in this disclosure, with various combinations of such, may also be implemented.

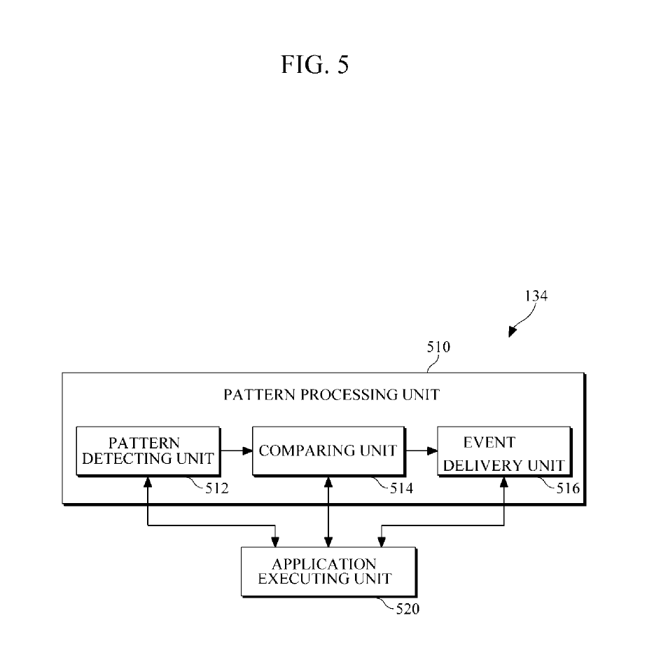

FIG. 5 is a block diagram illustrating an application service providing unit according to an exemplary embodiment of the present invention.

An application service providing unit 134 may include a pattern processing unit 510, and an application executing unit 520.

The pattern processing unit 510 may receive at least one of a user input signal and an action that triggers a sensor, generate input pattern information in accordance with the received input signal, and search for pattern information corresponding to the input pattern information and task information mapped to the pattern information based on mapping information. The pattern processing unit 510 may deliver an event associated with the retrieved task information to the application executing unit 520, allowing a task associated with the event to be executed.

The pattern processing unit 510 may include a pattern detecting unit 512, a comparing unit 514, and an event delivery unit 516.

The pattern detecting unit 512 monitors whether a user-defined pattern has been input. The pattern detecting unit 510 receives at least one of a user input signal and an action that triggers a sensor, and generates input pattern information based on the received input information. The pattern detecting unit 512 may generate pattern information based on the input signal, a technique for sensing an action, or the combination thereof. The pattern detecting unit 512 searches for pattern information that matches the input pattern information from mapping information stored in the mapping information storage unit 146.

In response to the pattern detecting unit 512 retrieving the pattern information matching the input pattern information, the comparing unit 514 may be enabled to search for application ID information and application state information, which may be included in task information mapped to the retrieved pattern information. The comparing unit 514 may compare the retrieved application ID information and application state information of the task information with application ID information and application state information of an application currently being executed or capable of receiving a user input.

Thus, the comparing unit 514 may determine that the application ID information and the application state information correspond to applications being executed or capable of receiving a user input. After which, the event delivery unit 516 may generate an event according to the event information from the task information mapped to the retrieved pattern information, and deliver the event to the application executing unit 520. An application being executed or that is available to receive a user input may be an application that is on a foreground of the display unit 150 or an application with the highest priority based on a user input signal.

The application executing unit 520 may monitor the operations of the pattern detecting unit 512, the comparing unit 514 and the event delivery unit 516. The application executing unit 520 may facilitate the execution of an application to perform the event transmitted from the event delivery unit 516. If the pattern detecting unit 512 fails to find pattern information that matches the input pattern information from the mapping information, or if the comparison indicates that the application ID information and application state information of the retrieved task information are not identical or similar to the application ID information and application state information of an application being executed, as a default, the application executing unit 520 may execute a task or event in a general operation mode, that may or may not be application independent.

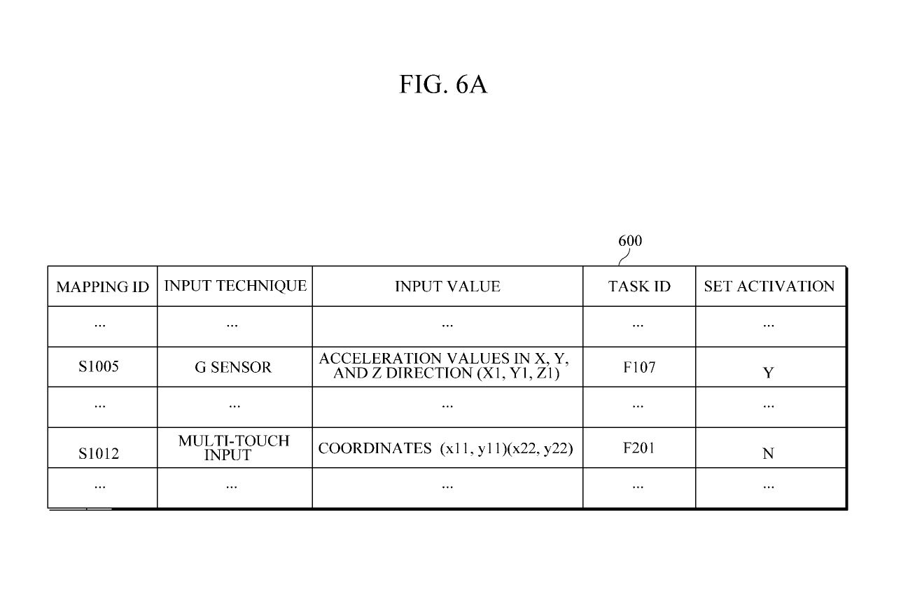

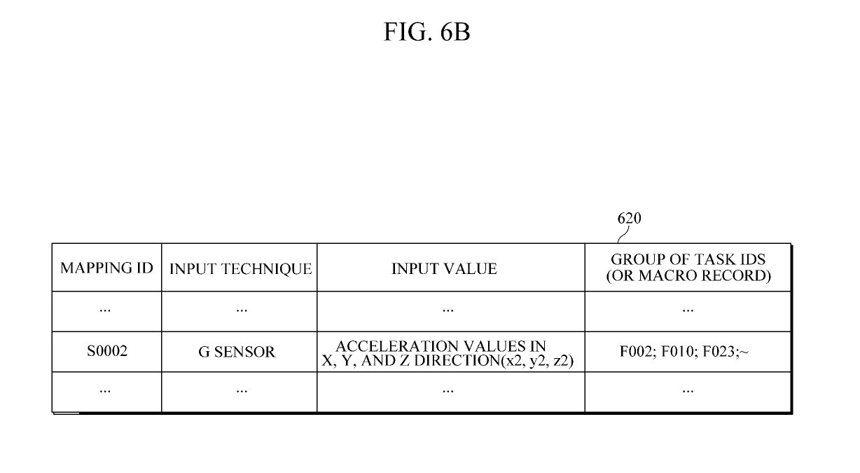

FIG. 6A is a table showing mapping information according to an exemplary embodiment of the present invention, and FIG. 6B is a table showing mapping information according to an exemplary embodiment.

Referring to FIG. 6A, the mapping information may include a mapping ID, an input technique, an input value, a task ID, and activation setting information. The mapping ID is identification information of mapping information. The task ID is similar to the task information shown in FIG. 4. The activation setting information is information that indicates the activation state of the mapping information, and may be selectively included in the mapping information. For example, if the activation setting information is set to ‘Y’ (yes), the corresponding mapping information is activated, and if the activation setting information is set to ‘N’ (no), the corresponding mapping information is inactivated. The activation setting information may be set to either ‘Y’ or ‘N’ based on a user selection.

The input technique and the input value may be similar to the corresponding categories of the pattern information, as shown in FIG. 3.

Referring to the table 600 shown in FIG. 6A, mapping information having S1005 as a mapping ID includes ‘G sensor’ as an input technique, an acceleration value (x1, y1, z1) of X-, Y-, and Z-axis direction as an input value, ‘F107’ as a task ID, and ‘Y’ as activation setting information. This indicates that if an input technique is a ‘G sensor’ and a pattern information of an input signal has an acceleration value (x1, y1, z1) of X-, Y-, and Z-axis direction, an event, application or task is enabled to be executed with reference to task information corresponding to the task ID.

More specifically, if based on correlating the task ID from the mapping information with the pattern information tables, retrieves an application ID information and application state information that corresponds to an application being executed, the event associated with the task ID may be performed or executed. Thus, using the tables and values of FIG. 6A and FIG. 4, if the application being executed is ‘MP3 player application’, and in a state that ‘music list is being displayed’, an event of ‘perform random play task’ may be executed.

Similarly, mapping information having ‘S1012’ as a mapping ID may cause an event of ‘change to capture mode’ to occur.

The table 620 of FIG. 6B shows that mapping information is produced by mapping a group of task IDs (or macro records) to a mapping ID. In response to receiving an input pattern corresponding to a specific input technique and input value, a corresponding group of events, tasks or applications associated with a plurality of task IDs may be performed. For example, in response to inputting pattern information corresponding to an acceleration value (x2, y2, z2) of X, Y, and Z direction, events corresponding to task IDs of F002, F010, F023, and the like, may be executed. The execution may be sequential. The events may be ascertained from a correspondence as exemplified in table 400.

In another example, if the task IDs are associated with macro records obtained by collecting runtime records, mapping information may be produced in such a manner that a mapping ID may be associated with a plurality of task IDs used to collect macro records.

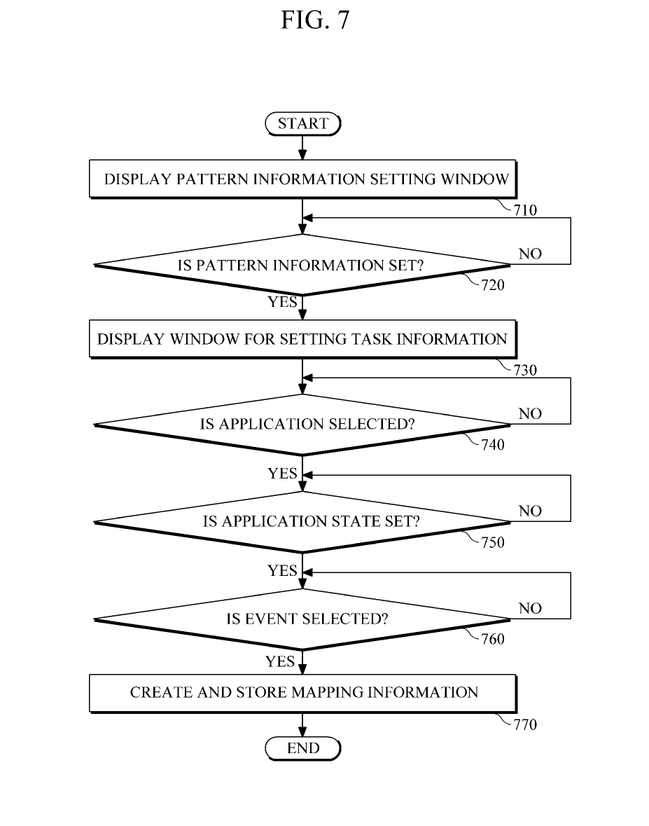

FIG. 7 is a flowchart of a method for setting user-defined pattern according to an exemplary embodiment of the present invention.

In operation 710, an application executing apparatus 100 provides pattern information setting window in response to a user input signal. The pattern information, as described above, may include information associated with an input technique, an input value, and the like. The window may be displayed after receiving a user input signal, or may be already initialized and displayed.

A determination is made if the pattern information is set in operation 720, and if yes, the application executing apparatus 100 provides a display window for setting task information in operation 730. The task information may correspond to an application, event or task to be executed. If the pattern information is not set, the application executing apparatus 100 returns to operation 710.

In operation 740, a determination is made as to whether an application (application, task or event) is selected. If no, the application executing apparatus 100 returns to this prompt. If yes, a determination as to whether an application state is set is made in operation 750. If no, the application executing apparatus 100 returns to this prompt. If yes, a determination is made as to whether an event is set in operation 760. If no, the application executing apparatus 100 returns to this prompt. If yes, the application executing apparatus 100 generates mapping information by mapping the set pattern information, and the set application type, and the set application state and event, and stores the generated mapping information.

Each window provided in operations 710 to 730 may be integrated into a single window and then provided to the user. In addition, in operations 730, 740, 750, and 760, various choices to select as options for setting the various parameters of the mapping information may be presented as a menu or other display graphical user interface.

Operations 740, 750 and 760, are provided as an example of supplementing and selectively adding information to mapping information. However, one of ordinary skill in the art may substitute various combinations of the parameters used. For example, macro record collection according to runtime may be used as an event. Execution information may be extracted from a macro record that is a group of the collected runtime records.

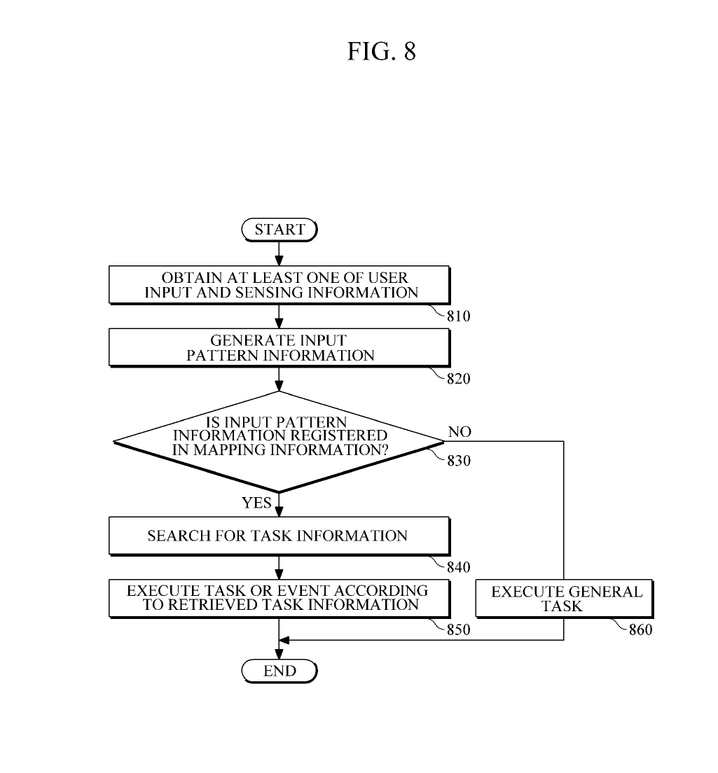

FIG. 8 is a flowchart illustrating a method for executing an application using a user-defined pattern according to an exemplary embodiment of the present invention.

In operation 810, the application executing apparatus 100 obtains a user input signal and an action that triggers a sensor. This input may be received as input values according to corresponding input techniques, and the application executing apparatus 100 may generate input pattern information based on the user input signal and the input technique.

The application executing apparatus 100 may check whether pattern information corresponding to the input pattern information has been registered in mapping information, in operation 820. If the pattern information matching the input pattern information has been registered in the mapping information (operation 830), task information mapped to the registered pattern information is searched for from the mapping information, in operation 840. An application, task or event is executed according to the retrieved task information in operation 850.

If the input pattern information has not been registered in the mapping information in operation 830, or if application ID information and application state information of the task information associated with the pattern information are not identical with an application that is available or currently being executed, the application currently being executed may receive a user input signal in general operation mode and process the user input signal in operation 860. The operation 860 for executing a general task may be selectively performed, and thus no operation may be performed.

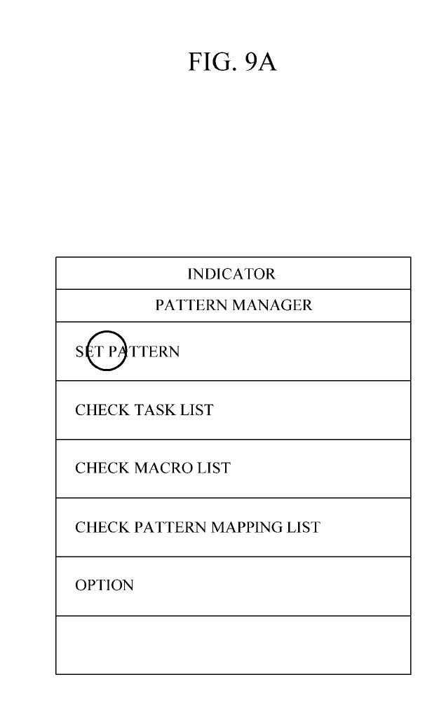

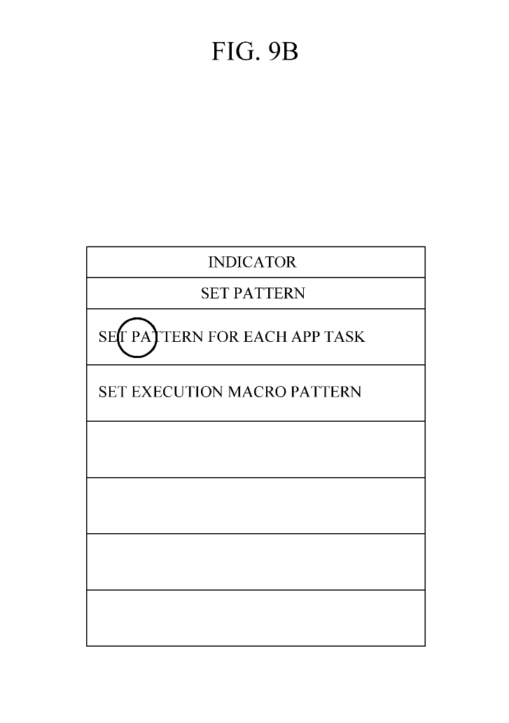

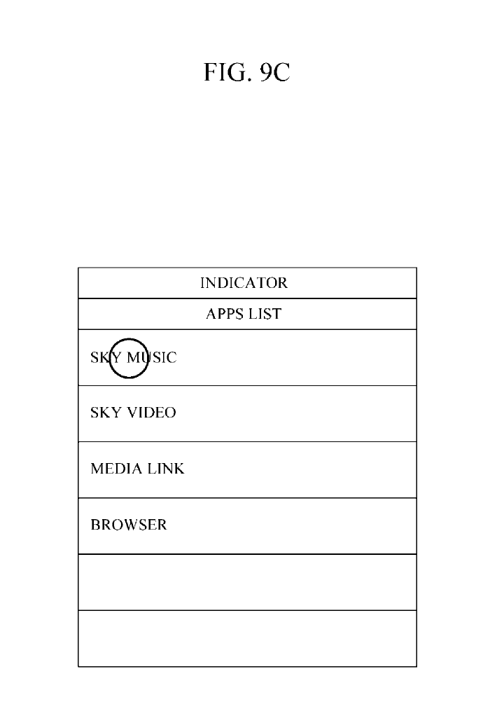

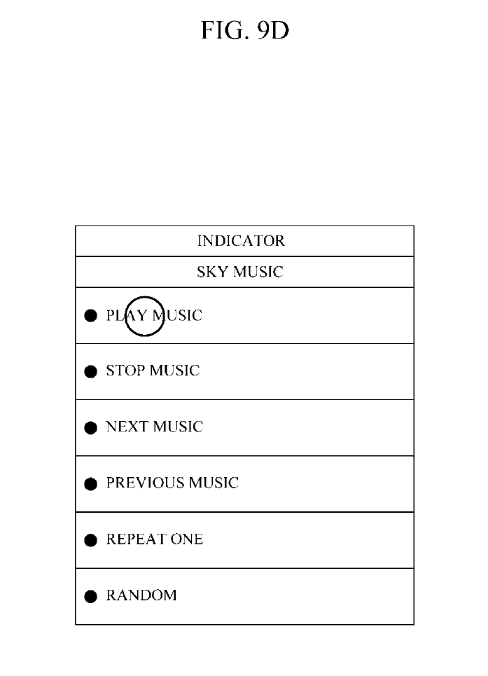

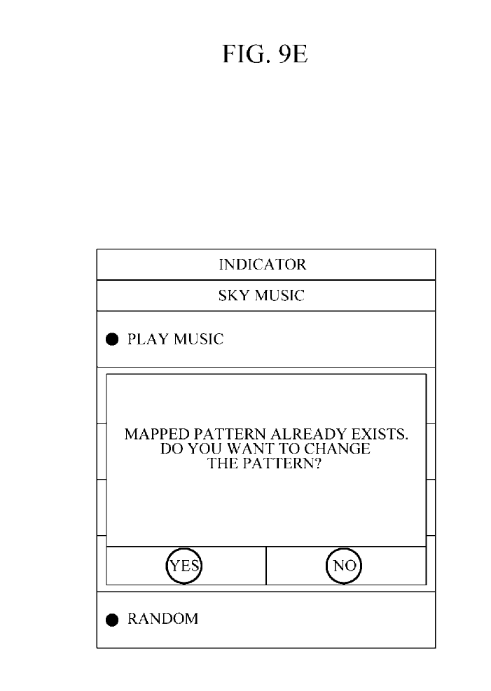

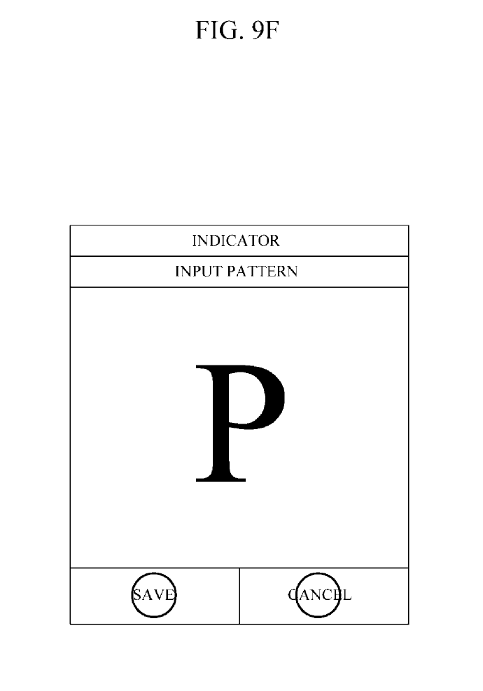

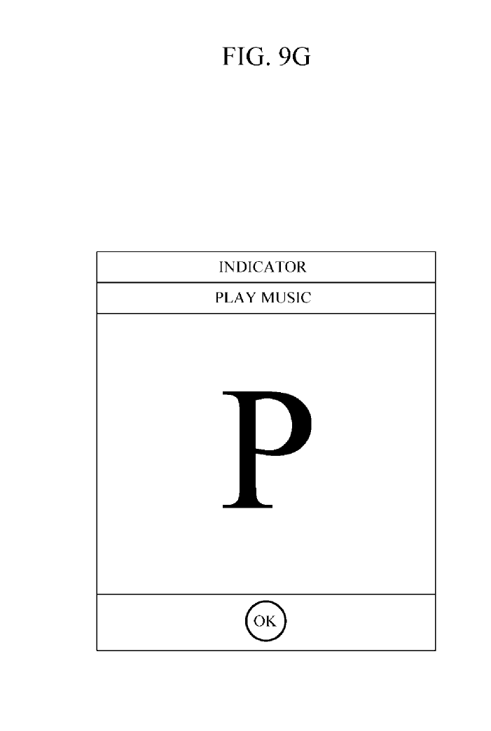

FIG. 9A is an illustration showing the setting of a user-defined pattern according to an exemplary embodiment of the present invention. FIG. 9B is an illustration showing the setting of a user-defined pattern according to an exemplary embodiment of the present invention. FIG. 9C is an illustration showing the setting of a user-defined pattern according to an exemplary embodiment of the present invention. FIG. 9D is an illustration showing the setting of a user-defined pattern according to an exemplary embodiment of the present invention. FIG. 9E is an illustration showing the setting of a user-defined pattern according to an exemplary embodiment of the present invention. FIG. 9F is an illustration showing the setting of a user-defined pattern according to an exemplary embodiment of the present invention. FIG. 9G is an illustration showing the setting of a user-defined pattern according to an exemplary embodiment of the present invention.

The pattern managing unit 132 shown in FIG. 1 may provide a pattern manager application for use in setting a user-defined pattern. FIG. 9A illustrates an initial display of the pattern manager application. The initial display of the pattern manager application may provide various items associated with managing pattern information, such as, “SET PATTERN,” “CHECK TASK LIST,” “CHECK MACRO LIST” and “CHECK PATTERN MAPPING LIST”. In FIG. 9A to 9G, a circle over a menu item indicates that the relevant item is selected in response to a user input signal.

In response to the user's selecting “SET PATTERN,” a pattern setting display for use in selecting a type of the pattern settings may be provided, as shown in FIG. 9B. If the user selects “SET PATTERN FOR EACH APP TASK,” an apps list display for use in selecting a type of an application may be provided, as shown in FIG. 9C.

With respect to applications shown in the apps list display of FIG. 9C, the various applications may be set to ‘available’. For example, in the case of an Android application that may be run on the Android platform, the task information of the application may be defined using AndroidManifest.xml. This is an Android application configuration tool to define an activity, a service, and the like of components used in the application. The pattern managing unit 132 may provide a list of applications that have previously been set to available in the apps list display. If an application, “SKY MUSIC,” is selected from the apps list in response to a user input signal, a task information list may be provided, as shown in FIG. 9D.

If a task, “PLAY MUSIC,” is selected from the display of FIG. 9D in response to a user input signal, the pattern managing unit 132 may check whether a user-defined pattern mapped to the task information of the selected task is stored. If the user-defined pattern mapped to the task information of the selected task exists or has been previously stored, the pattern managing unit 132 may provide a notification of this, and provide the display as shown in FIG. 9E.

If the user selects “YES” in the display shown in FIG. 9E, the pattern managing unit 132 may provide a user-defined pattern input display as shown in a display of FIG. 9F. The user can input gestures by touching the display shown in FIG. 9F. A letter “P” in FIG. 9F represents a gesture input by a user's touch. The pattern managing unit 132 may combine the input gesture information and various sensor values of the apparatus 100 to generate pattern information with respect to the user-defined pattern. The pattern information may be stored in the pattern information storage unit 142.

If the user selects “OK” in a display as shown in FIG. 9G, the user-defined pattern settings are completed for the corresponding application task, and the pattern managing unit 130 may provide the initial display as shown in FIG. 9A.

If the pattern managing unit 132 determines that there is no user-defined pattern mapped to the selected task, the pattern managing unit 132 may provide the display as shown in FIG. 9F. In addition, if the user selects “CANCEL” from the display shown in FIG. 9E, the pattern managing unit 132 may provide the display shown in FIG. 9D.

Thus, the user-defined pattern (or pattern information) for use in executing a task of an application, for example, a task of “PLAY MUSIC” of an application “SKY MUSIC” can be executed in response to a user input signal corresponding to the pattern input to the display shown in FIG. 9F.

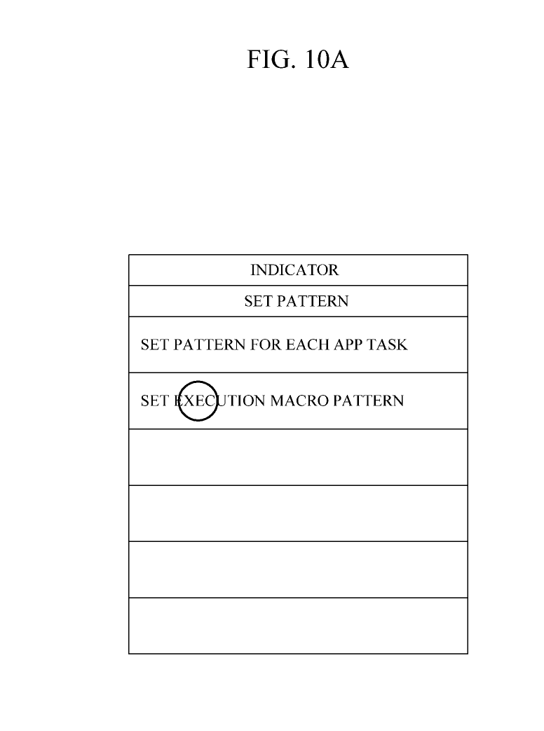

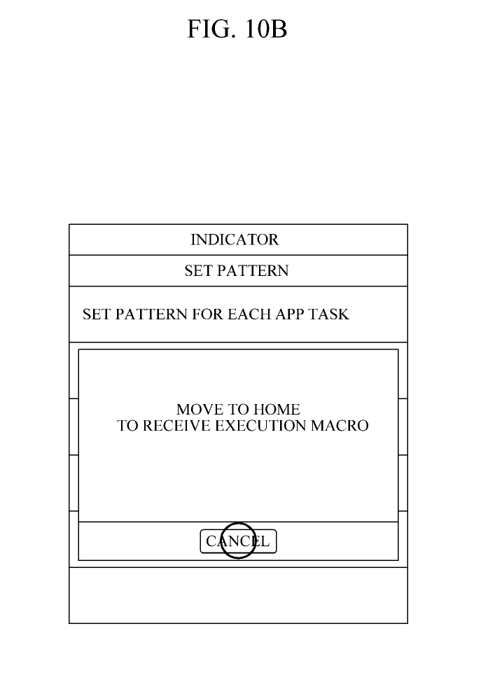

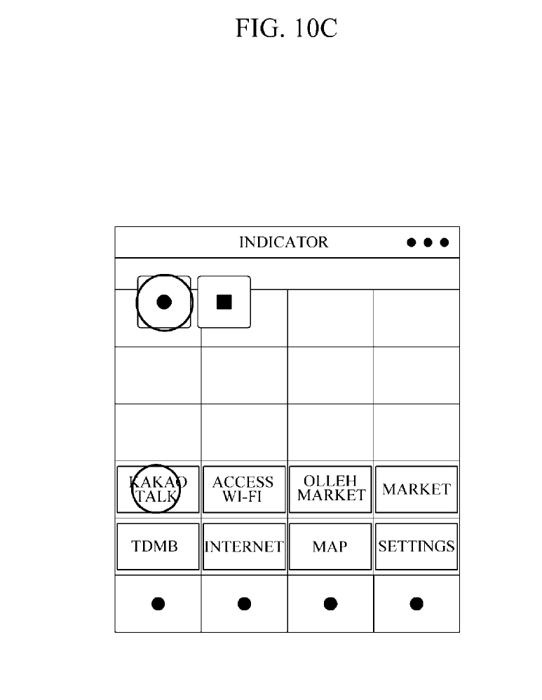

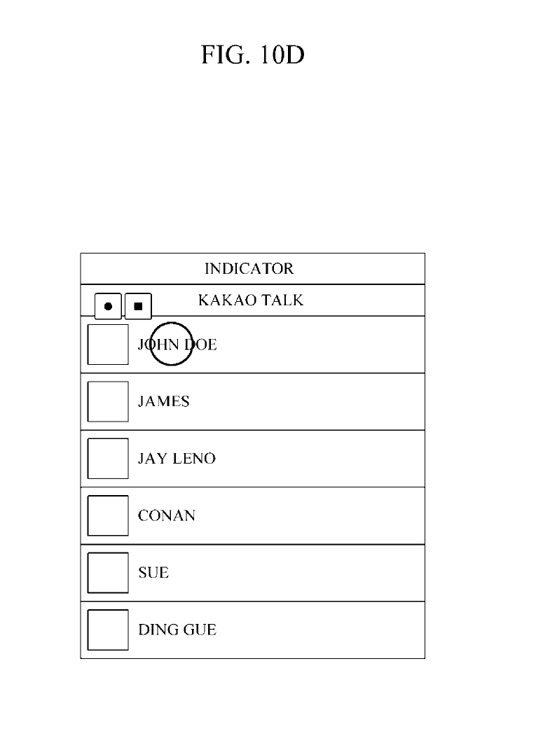

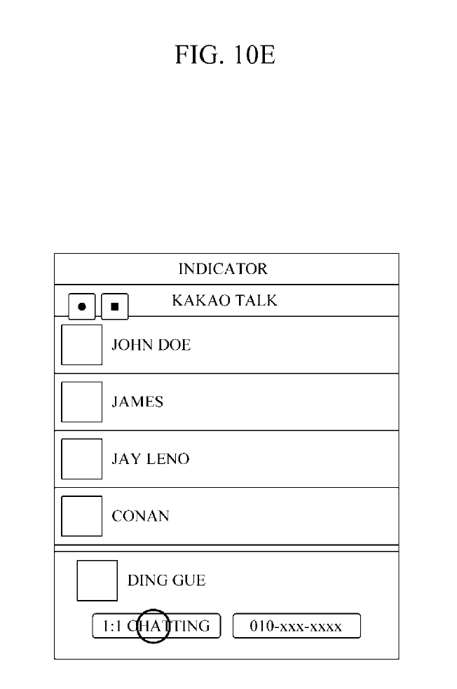

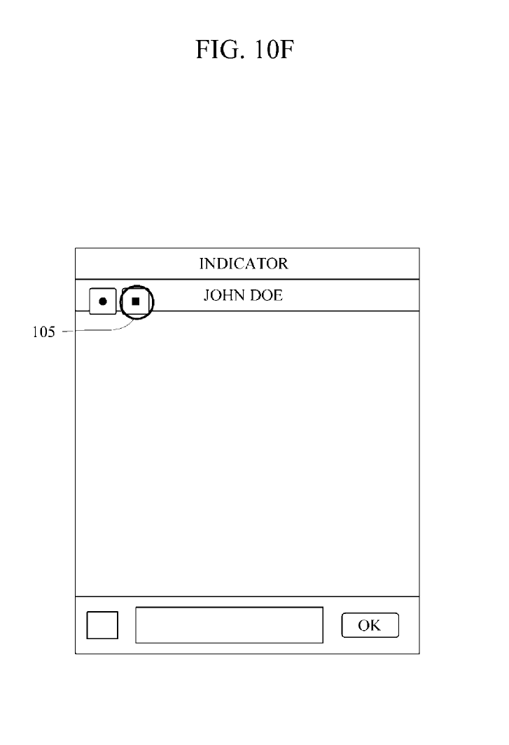

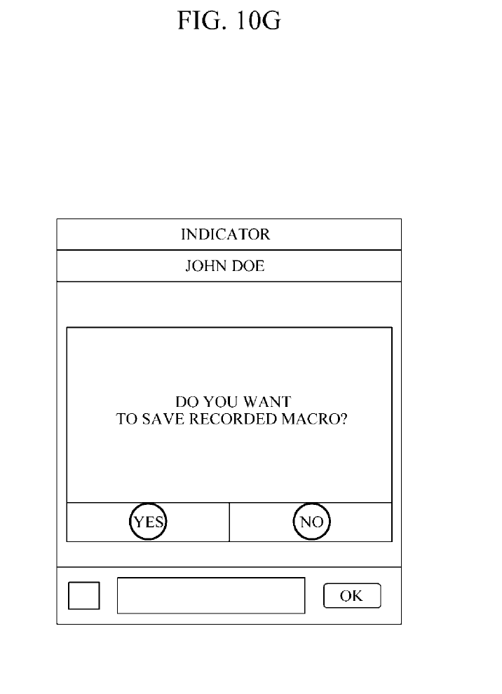

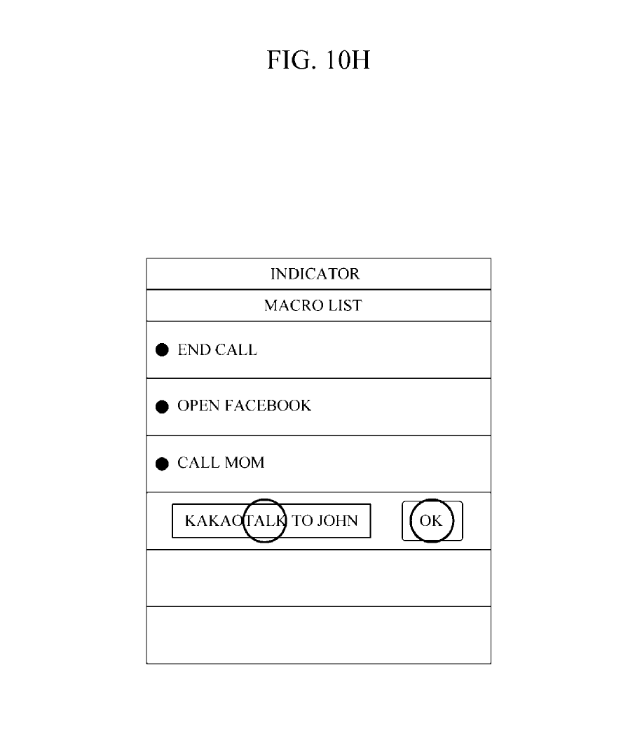

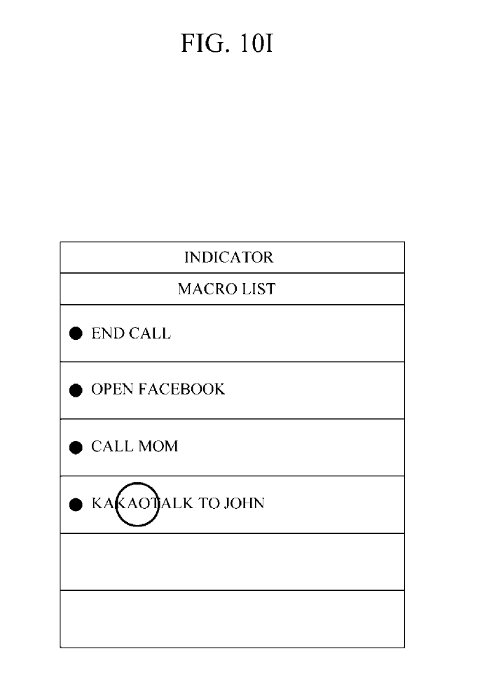

FIG. 10A is an illustration showing task extracting based on a user-defined pattern according to an exemplary embodiment of the present invention. FIG. 10B is an illustration showing task extracting based on a user-defined pattern according to an exemplary embodiment of the present invention. FIG. 10C is an illustration showing task extracting based on a user-defined pattern according to an exemplary embodiment of the present invention. FIG. 10D is an illustration showing task extracting based on a user-defined pattern according to an exemplary embodiment of the present invention. FIG. 10E is an illustration showing task extracting based on a user-defined pattern according to an exemplary embodiment of the present invention. FIG. 10F is an illustration showing task extracting based on a user-defined pattern according to an exemplary embodiment of the present invention. FIG. 10G is an illustration showing task extracting based on a user-defined pattern according to an exemplary embodiment of the present invention. FIG. 10H is an illustration showing task extracting based on a user-defined pattern according to an exemplary embodiment of the present invention. FIG. 10I is an illustration showing task extracting based on a user-defined pattern according to an exemplary embodiment of the present invention.

FIG. 10A shows that a menu, “SET EXECUTION MACRO PATTERN,” is selected in the display shown in FIG. 9B. “SET EXECUTION MACRO PATTERN”, which allows the collection of macro records for extracting the execution information. In response to selecting “set execution macro pattern” in the display shown in FIG. 10A, the pattern managing unit 132 may provide the display shown in FIG. 10B to receive an execution macro.

The display shown in FIG. 10B provides to notification that the pattern managing unit 132 may start collecting macro records. In response to the user selecting “CANCEL” in the display shown in FIG. 10b, it is recognized that the user does not wish to record this information, and the display shown in FIG. 10A may be provided again. If a reference period of time (for example, n seconds) has elapsed without “CANCEL” being selected, the display shown in FIG. 10B is changed to a display shown in FIG. 10C.

A record start icon 101 on the display of FIG. 10C is an icon to receive a first user input signal that instructs runtime recording to start. If the record start icon is selected and an application icon for extracting task information in response to a user input signal is also selected, an application corresponding to the application icon is executed, and runtime record collecting begins. In addition, according to the selection of the application icon, an application running display shown in FIG. 10D is provided.

In the case where the application corresponding to the selected application icon is “KAKAOTALK,” as shown in the display of FIG. 10D, a list of all available recipients may be provided. If the user selects “JOHN DOE” from the list, a display showing “JOHN DOE” and a 1:1 chatting icon and/or a voice call icon appears, as shown in FIG. 10E. In response to user's selecting the 1:1 chatting icon from the display of FIG. 10E, a 1:1 chatting display that allows chat with the selected recipient is provided, as shown in FIG. 10F.

If a record end icon for receiving a second user input signal that indicates the termination of collecting runtime records, the runtime record collecting process is terminated, and a display to provide a check window for the user to confirm whether to store a macro record as part of a group of the collected runtime records is provided, as shown in FIG. 10G. In response to selecting “YES” in the display of FIG. 10G, the macro record is stored, and a display for the user to enter a name of the stored macro record is provided, as shown in FIG. 10H. If the user enters the name of the macro record as “KAKAOTALK TO JOHN” in the display of FIG. 10H, a macro list having a new macro record added is provided, as shown in FIG. 10I.

In response to user's selecting “KAKAOTALK TO JOHN” from the macro list, the same display as shown in FIG. 9F may be provided for the user to input pattern information corresponding to the selected macro record. Accordingly, the pattern information corresponding to the selected macro record is input, and stored, the macro record associated with the input pattern information is mapped to generate mapping information.

Once the mapping information is generated according to the above-described technique, the user can perform “KAKAOTALK TO JOHN” by entering a user-defined pattern. Therefore, a user-defined pattern mapped to a specific task of an application or a recorded macro associated with an action, may increase the convenience in executing an application, task or event.

The methods and/or operations described above may be recorded, stored, or fixed in one or more computer-readable storage media that includes program instructions to be implemented by a non-transitory computer to cause a processor to execute or perform the program instructions. The media may also include, alone or in combination with the program instructions, data files, data structures, and the like. Examples of a non-transitory computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A device to execute an application, comprising:
an input unit to receive a first input and a second input;
a pattern setting unit to set a reference pattern based on the first input and to map the reference pattern to an event of the application; and
a control unit to execute the event in response to the second input corresponding to the reference pattern.

2. The device according to claim 1, wherein the input unit further comprises:
a touch input unit to receive a touch input; and
a sensor unit to sense a sense parameter,
wherein if the sensed parameter matches a reference parameter, the control unit executes the event.

3. The device according to claim 1, wherein the event is a task of the application.

4. The device according to claim 3, wherein the task is executed in response to the application being in a state of execution.

5. The device according to claim 3, wherein a general operation is executed in response to the application being in a state of non-execution.

6. The device according to claim 1, wherein the reference pattern is stored in a look-up table.

7. The device according to claim 2, wherein the sensor unit is a gravity sensor, global positioning satellite sensor, gyro sensor, image sensor, or a combination thereof.

8. The device according to claim 2, wherein the touch input unit is a touch display.

9. The device according to claim 1, wherein the control unit determines if the reference pattern has been mapped to the event or another event.

10. A method for executing an application, comprising:
receiving a first input and a second input;
setting a reference pattern based on the first input;
mapping the reference pattern to an event; and
executing the event in response to the second input corresponding to the reference pattern.

11. The method according to claim 10, wherein the receiving of the first input and the second input comprises:
receiving a touch input;
sensing a sense parameter; and
executing the event based on the sensed parameter matching a reference parameter.

12. The method according to claim 10, wherein the event is a task of the application.

13. The method according to claim 12, wherein the task is executed in response to the application being in a state of execution.

14. The method according to claim 12, wherein a general operation is executed in response to the application being in a state of non-execution.

15. The method according to claim 10, further comprising storing the reference pattern in a look-up table.

16. The method according to claim 11, wherein the sense parameter is a gravity measurement, global position, acceleration, image, or a combination thereof.

17. The method according to claim 11, wherein the touch input is received via a touch display.

18. The method according to claim 10, further comprising determining if the reference pattern has been mapped to the event or another event.

19. A method for setting a reference pattern, comprising:
receiving a first input;
setting the reference pattern based on the first input; and
mapping the reference pattern to an event of an application,
wherein the event is executed in response to a duplication of the reference pattern.

20. The method according to claim 19, wherein the event is a macro recordation of a runtime record.
